(19) United States
(12) Patent Application Publication
(10) Pub. No.: US 2022/0142032 A1
(43) Pub. Date: May 12, 2022

(54) FOOT SHOVEL

(71) Applicant: Darion Worthy, Lakewood, OH (US)

(72) Inventor: Darion Worthy, Lakewood, OH (US)

(21) Appl. No.: 17/433,622

(22) PCT Filed: Feb. 25, 2020
(86) PCT No.: PCT/US2020/019617

§ 371 Date: Aug. 25, 2021

Related U.S. Application Data
(60) Provisional application No. 62/810,020, filed on Feb. 25, 2019.

(51) Int. Cl. A01B 1/02

(52) U.S. Cl. CPC A01B 1/028

(57) ABSTRACT

Provided is a foot shovel comprising a pedal-activated lift and release mechanism. The foot shovel may allow for the relocation of a load, such as snow, dirt, rocks, sand, concrete, and the like, while minimizing exertion of the back, shoulders, and upper body. The foot shovel instead may redirect that exertion to an area of the body that may be less prone to complications and strain due to sudden movement, such as the feet, legs, and lower body. The pedal-activated lift and release mechanism may comprise a series of levers, arms, and axles that transition the foot shovel from a resting state where the foot shovel may acquire a load, to a lifting state that allows movement of the load to a desired location, and, finally, to a release state wherein the load is released from the foot shovel. The pedal-activated lift and release mechanism may transition back to a resting state to repeat the process of relocation. The pedal-activated lift and release mechanism may be actuated by a stepping motion by a user's foot.

### CROSS REFERENCE TO RELATED APPLICATIONS

This application claims priority to U.S. Provisional App. No. 62/810,020, filed Feb. 25, 2019 and entitled “Foot Shovel,” which is incorporated herein by reference in its entirety.

### FIELD OF THE INVENTION

The present disclosure relates generally to a shovel and, more particularly, to a shovel comprising a pedal-activated lift and release mechanism, and methods of use thereof.

### BACKGROUND

Shoveling snow may involve strenuous bending and lifting of the back, shoulders, and upper body, and may cause muscle strain or lead to other serious injury. In some instances, the physical exertion of manually moving, lifting, and throwing a load may increase an individual's risk for cardiac arrest and heart failure as the movement may cause an acute increase in an individual's blood pressure and heart rate. Additionally, this exertion involving the arms, as compared to the legs, may be more straining on an individual's body and more likely to cause a surge in blood pressure and heart rate. Often, this sudden and intense increase in blood pressure and heart rate can be more severe than working out on a treadmill. Cold temperatures and conditions may additionally increase an individual's risk of injury during the strenuous activity of shoveling as the cold air can constrict blood vessels, decrease the amount of oxygen received by the heart, and generally cause tightness throughout an individual's muscles and joints.

A study by U.S. Nationwide Children's Hospital found that 1,647 fatalities from cardiac-related injuries associated with shoveling snow occurred between 1990 through 2006, amounting to an average of 100 deaths per year. Others, including the director of preventative cardiology and cardiac rehabilitation at William Beaumont Hospital, Michigan, estimate that this number could be much higher. The American Heart Association has warned of the health hazards associated with shoveling snow, and MetroHealth has advised that even the act of pushing a heavy snow blower can increase the risk of injury during snow removal.

While shoveling snow is an example of strenuous activity that may lead to health complications, these risks may be associated with any bending, lifting, throwing, carrying, holding, or other strenuous activity on the upper body that may occur when moving a load, and the risk of any of these activities may be compounded by cold conditions.

As a result, there is a need for a shovel device that reduces exertion of the back, shoulders, and upper body, and instead redirects that exertion to an area of the body less prone to complications due to sudden movement, such as the feet, legs, and lower body.

### SUMMARY

Disclosed is a foot shovel. In an embodiment, the foot shovel may include a pedal-activated lift and release mechanism. in an embodiment, the foot shovel may comprise a body having a first end and a second end, a base disposed at the first end of the body, the base comprising at least one member configured to allow lateral movement of the foot shovel, a handle disposed at the second end of the body, a blade configured to receive and hold a load, and a multi-lever actuation mechanism. The multi-lever actuation mechanism may be configured to lift the blade to a lifting position by a first force and may rotate the blade to a release position by a second force.

In an embodiment, the multi-lever actuation mechanism may comprise a slot and a rod. The rod may move from a start point in the slot to a stop point in the slot as the foot shovel moves from a resting position to the lifting position. The multi-lever actuation mechanism may maintain the blade in a non-vertical position as the rod moves in the slot and as the foot shovel moves from a resting position to the lifting position. The multi-lever actuation mechanism may rotate the blade to a vertical position when the rod hits the stop point and as the foot shovel moves from the lifting position to the release position.

In an embodiment, the multi-lever actuation mechanism may comprise a first set of arms having a first and a second end. The first set of arms may be anchored to the base at a first rotatable point and the first end may serve as the actuator of the multi-lever actuation mechanism. The multi-lever actuation mechanism may further comprise a second set of arms having a first and a second end. The first end of the second set of arms may be anchored to the base at a second rotatable point. In an embodiment, the second end of the first set of arms may serve as a slidable guide to the second set of arms. In an embodiment, the second end of the first set of arms may slidably engage with a slot on the second set of arms. The multi-lever actuation mechanism may further comprise a third set of arms having a first and a second end. The first end of the third set of arms may be anchored to the second end of the first set of arms at a third rotatable point. The second end may comprise a slot. The multi-lever actuation mechanism may further comprise a fourth set of arms having a first and a second end. The first end of the fourth set of arms may be anchored to the second end of the second set of arms at a fourth rotatable point. The fourth set of arms may be slidably engaged with the slot of the third set of arms. The blade may be anchored to the fourth set of arms.

In an embodiment, the first set of arms may be configured to rotate about the first rotatable point, the second set of arms may be configured to rotate about the second rotatable point, the third set of arms may be configured to rotate about the third rotatable point, the fourth set of arms may be configured to rotate about the fourth rotatable point, and the fourth set of arms may be configured to slide across the slot to a stop point, as the foot shovel moves from a resting position to the lifting position.

In an embodiment, the fourth set of arms may remains substantially parallel to the ground as the foot shovel moves from a resting position to the lifting position. The fourth set of arms may be configured to rotate about the stop point as the foot shovel moves from the lifting position to the release position. The fourth set of arms may rotate to a substantially perpendicular position as the foot shovel moves from the lifting position to the release position.

In an embodiment, the multi-lever actuation mechanism may be actuated by a manually-applied downward force onto the first end of the first set of arms. In an embodiment, the body may be adjustable in angle. In an embodiment, the at least one member configured to allow lateral movement of the foot shovel may be a sliding member. In an embodiment, the at least one member configured to allow lateral movement of the foot shovel may be a wheel. In an embodiment, the blade may be removable and interchangeable.

In an embodiment, the foot shovel may include a pedal-activated lift and release mechanism and comprise a frame having a body and a handle, a base operatively attached to the body, the base comprising at least one member configured to allow lateral movement of the foot shovel, a blade configured to receive and hold a load, and a multi-lever actuation mechanism comprising at least one set of rotatable arms, a sliding member, and a slot, wherein the sliding member is slidably engaged with the slot.

In an embodiment, the sliding member may slide through the slot to a stop point as the foot shovel moves from a resting position to a lifting position, and the sliding member may cause the blade to rotate at the stop point to move the shovel from a lifting position to a release position.

### BRIEF DESCRIPTION OF THE DRAWINGS

The present teachings may be better understood by reference to the following detailed description taken in connection with the following illustrations, wherein:

FIGS. 1A-C show various views of an embodiment of a foot shovel comprising a pedal-activated lift and release mechanism and detachable blade;

FIGS. 2A-2B are side views of a foot shovel having a body that is adjustable in angle;

FIGS. 3-5 show various views of an embodiment of a foot shovel in a resting position;

FIG. 6 is a perspective view of an embodiment of a foot shovel in transition between a resting position and a lifting position;

FIG. 7 is a perspective view of an embodiment of a foot shovel in a lifting position;

FIG. 8 is a perspective view of an embodiment of a foot shovel in transition between a lifting position and a release;

FIG. 9 is a perspective view of an embodiment of a foot shovel in transition between a lifting position and a release;

FIG. 10 is a perspective view of an embodiment of a foot shovel in a release position;

FIG. 11 is a partial side view of an embodiment of a foot shovel in transition between a lifting position and a release position;

FIGS. 12A and 12B are side and top views of various embodiments of a base of a foot shovel comprising at least one sliding member and a selectively extendable wheel;

FIG. 13 is a perspective view of a foot shovel with an interchangeable blade; and

FIGS. 14-17 show various views of an embodiment of a foot shovel comprising a pedal-activated lift and release mechanism having a second slot.

### DETAILED DESCRIPTION

Reference will now be made in detail to exemplary embodiments of the present teachings, examples of which are illustrated in the accompanying drawings. It is to be understood that other embodiments may be utilized and structural and functional changes may be made without departing from the respective scope of the present teachings. Moreover, features of the various embodiments may be combined or altered without departing from the scope of the present teachings. As such, the following description is presented by way of illustration only and should not limit in any way the various alternatives and modifications that may be made to the illustrated embodiments and still be within the spirit and scope of the present teachings. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Further, unless context suggest otherwise, descriptions of shapes (e.g., circular, rectangular, triangular, etc.) refer to shapes meeting the definition of such shapes and general representation of such shapes. For instance, a triangular shape or generally triangular shape may include a shape that has three sides and three vertices or a shape that generally represents a triangle, such as a shape having three major sides that may or may not have straight edges, triangular like shapes with rounded vertices, etc.

While embodiments may refer to a particular example of the described foot shovel as for use in snow applications, it is noted that disclosed embodiments may be applicable to various other items, products, and industries. Described embodiments may be utilized for any application that requires relocation of a load, such as snow, dirt, rocks, sand, concrete, and the like. As an example, the foot shovel and/or pedal-activated lift and release mechanism may be utilized in construction, industrial, personal applications, etc. The foot shovel may be used with manual or electronic actuation, and may adapted to be used in applications of any scale.

Some devices require a user to push and lift a shovel while clearing snow, relying heavily on an individual's upper body, including their back, shoulders, and arms. Some shovels use large blades to be able to move more amounts of snow. This, however, increases the weight on the shovel and requires the user to work even harder. As the user continues to shovel, they may overexert themselves, overheat, or otherwise have negative physical experiences while shoveling, such as a sudden surge in blood pressure or heart rate. The repeated lifting and pushing of the snow may cause strain on the body and, in some cases, may result in injury. Cold conditions may exacerbate injuries or make an individual more prone to certain injuries. Cold conditions may cause constriction of blood vessels and cause a cardiac event while shoveling.

Disclosed is a foot shovel comprising a pedal-activated lift and release mechanism. The foot shovel may allow for the relocation of a load, such as snow, dirt, rocks, sand, concrete, and the like, while minimizing exertion of the back, shoulders, and upper body. The foot shovel instead may redirect that exertion to an area of the body that may be less prone to complications and strain due to sudden movement, such as the feet, legs, and lower body. The pedal-activated lift and release mechanism may comprise a series of levers, arms, and axles that transition the foot shovel from a resting state where the foot shovel may acquire a load, to a lifting state that allows movement of the load to a desired location, and, finally, to a release state wherein the load is released from the foot shovel. The pedal-activated lift and release mechanism may transition back to a resting state to repeat the process of relocation. The pedal-activated lift and release mechanism may be actuated by a stepping motion by a user's foot.

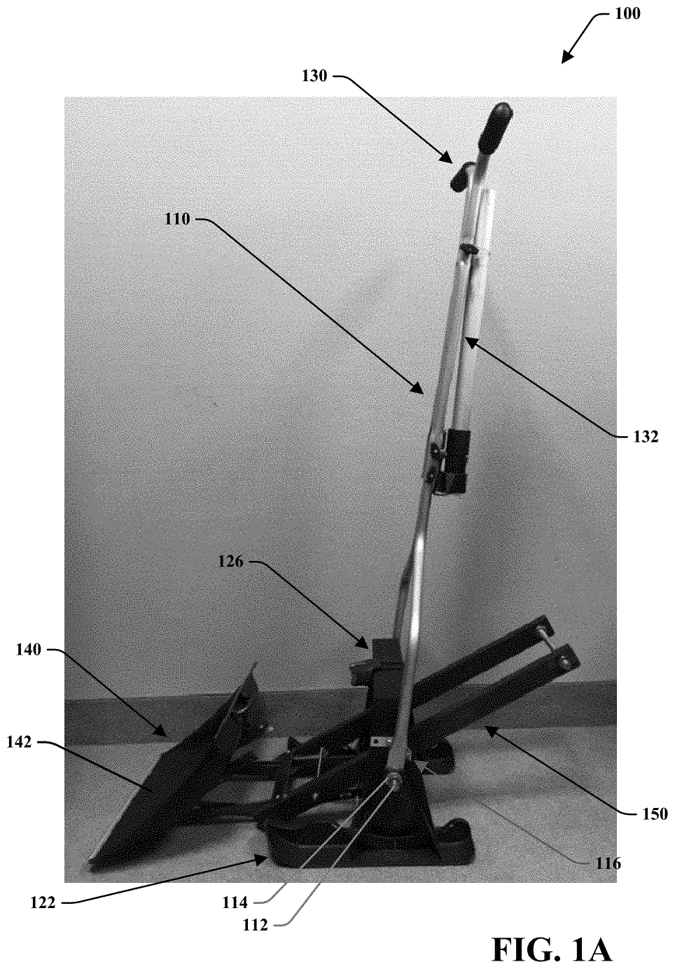

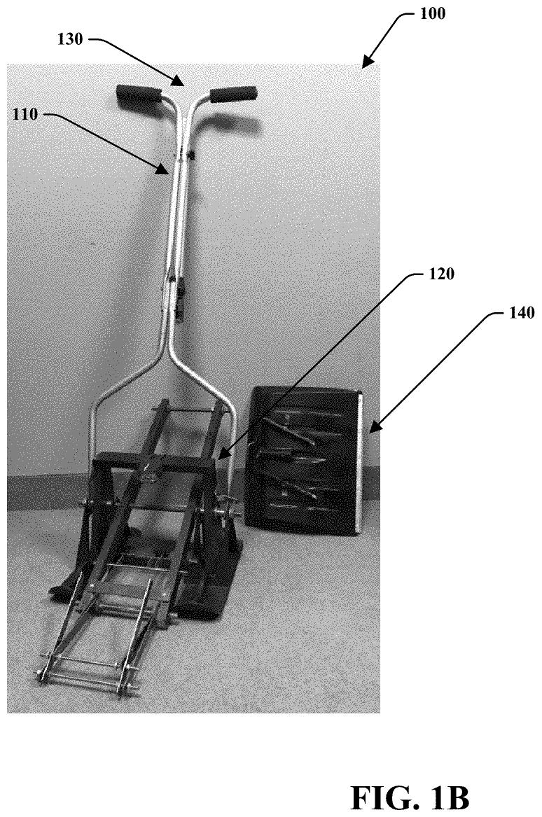

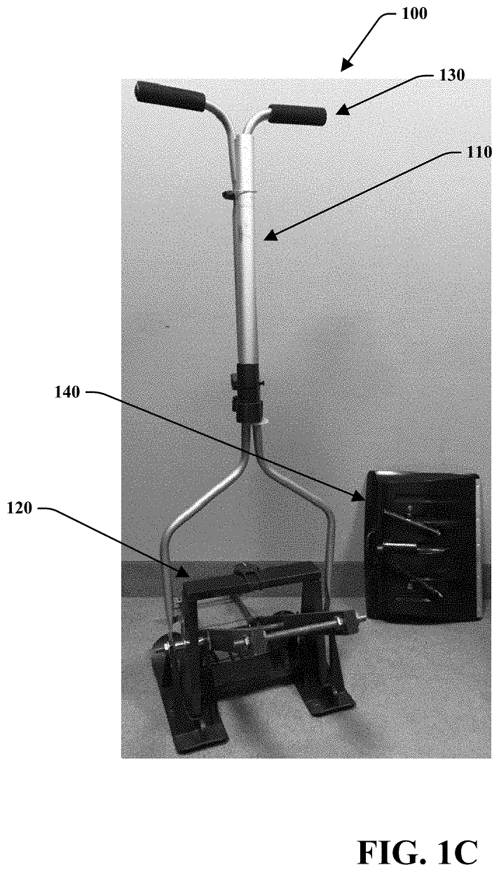

FIGS. 1A-C depict a foot shovel 100. The foot shovel 100 may generally comprise a body 110, a base 120, a handle 130, a blade 140, and an actuation mechanism 150. The foot shovel 100 may allow for moving or shoveling material with reduced strain on a user. As described herein, the foot shovel 100 may acquire material in the blade 140 while the blade 140 is in a resting position, the foot shovel 100 may mechanically lift and displace the blade 140 to move material and release the material to a desired other location, and the blade 140 may mechanically return to a resting position for iterative removal of material, such as snow from a driveway, sidewalk, or road. The actuation mechanism may include a series of integrated levers to facilitate the lifting and releasing mechanism of the foot shovel 100.

The body 110 of the foot shovel 100 may be coupled to the base 120. The body 110 may be hingedly or rotatably attached to the base 120 by, for example, an axle 112 and fastening mechanism, such as a bolt 114. In an embodiment, the body 110 may include an elongated frame portion that branches into at least two attachment portions and the attachment portions may straddle and attach to opposite sides of the base 120. In an embodiment, the axle 112 may traverse the width of the base 120 and each end of the axle 112 may operatively couple to an attachment portion and to at least one bolt 114 on each end of the axle 112. In an embodiment, the foot shovel 100 may comprise more than one axle 112 that may operatively couple to an attachment portion and to at least one bolt 114. In an embodiment, the body 110, or attachment portions thereof, may comprise receiving members, such as apertures, that receive the axle 112 of the base 120. The axle 112 may be secured or locked into place by a bolt 114. Although an axle 112 and bolt 114 is herein described as facilitating the attachment between the body 110 and the base 120 of the foot shovel 100, it is noted that any suitable attachment may be used, including hinges, rotatable attachments or locks, channel locks, bayonet-style locks, fiction fit connections, fasteners, magnets, or the like.

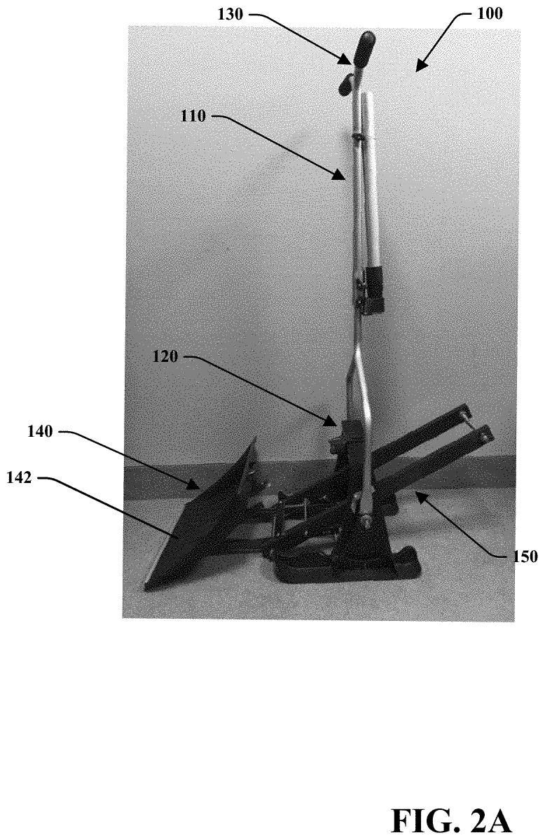

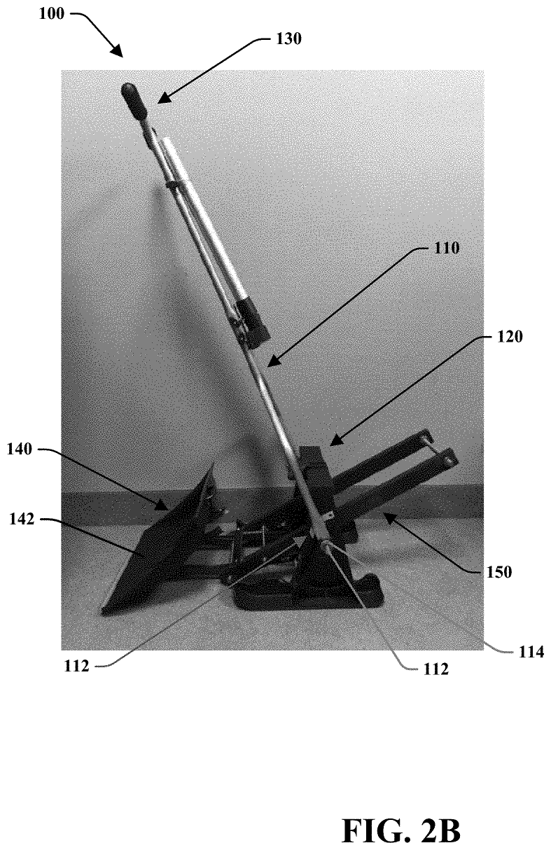

The body 110 may be adjustable in angle, as partially shown in FIGS. 1-2. In an embodiment, the body 110 is freely rotatable about the axle 112. In an aspect, a stop 116 may be used to limit angular rotation and prevent the body 110 from extending too far in any direction. As shown in FIGS. 1-2, the stop 116 may be used on either side of the body 110 to limit angular rotation in a forward or backward direction of the body 110. The stop 116 may comprise a physical stop, such as a projection or protrusion that blocks or interrupts the rotational path of the body 110. It is noted that other stops may be utilized, such as magnetic stops, electric stops, mechanical stops, or the like. In an example, the stop 116 may allow a user to rest the body 110 forward without the body 110 falling to the ground upon release, as illustrated in FIG. 2B, or the stop 116 may allow a user to rest the body 110 at another angle, such as a backward angle, to prevent the body 110 from failing to the ground upon release, as illustrated in FIG. 1A. The stop 116 may be used to selectively lock the body 110 at any particular angle as desired by the user. The stop 116 may hold the body 110 at a certain angle during use or during nonuse of the foot shovel, and may prevent the body 110 from falling to an undesirable angle, such as to the ground, which would then require a user to bend and retrieve the body. It is noted that the base 120 may similarly be adjusted to manipulate the angle of the foot shovel 100.

The body 110 may be adjustable in height. Adjusting the height of the body 110 may accommodate a user's preferences for use, e.g. based on the user's height, may facilitate ease of storage, transportation, use, and the like. In an embodiment, the height of the body 110 may be adjusted by telescoping members of the frame of the body 110 that can extend, retract, and lock at various lengths. In an embodiment, the body 110 may include insertable and removable attachments that vary the height of the body 110. In an embodiment, the foot shovel 100 may include multiple body 110 frames, or portions thereof, having different lengths that may be interchanged based on a desired height of the body 110. It is noted that the base 120 may similarly be adjusted to manipulate the height of the foot shovel 100.

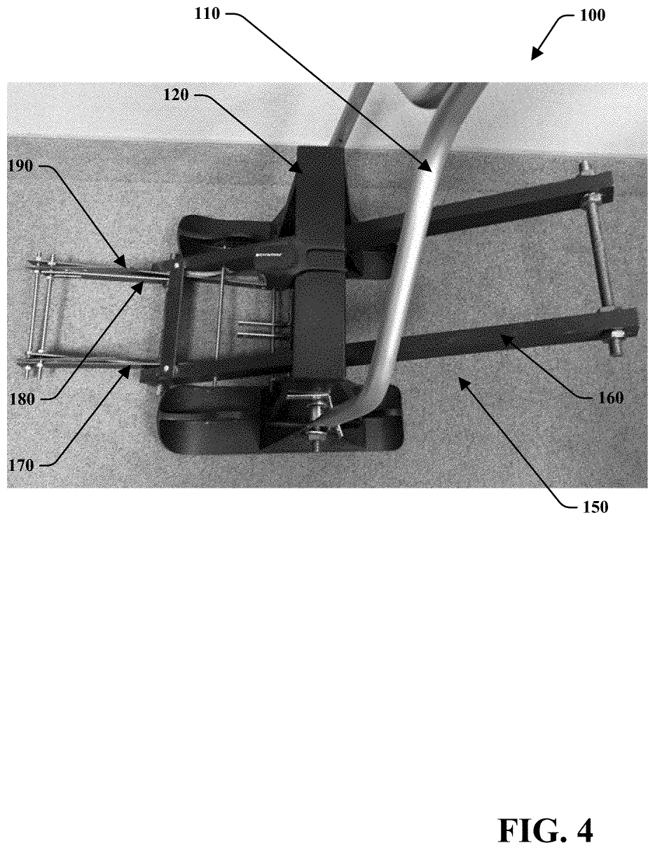

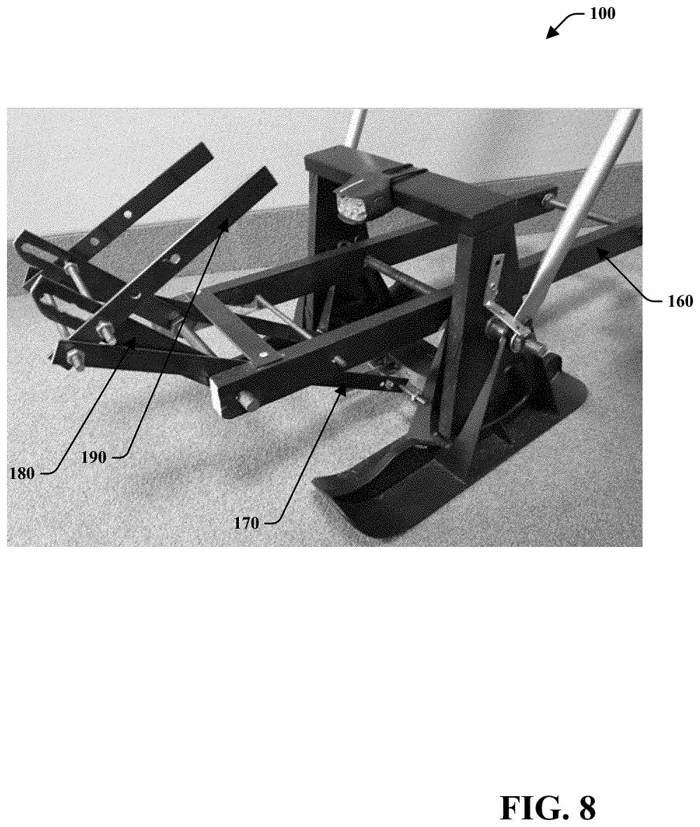

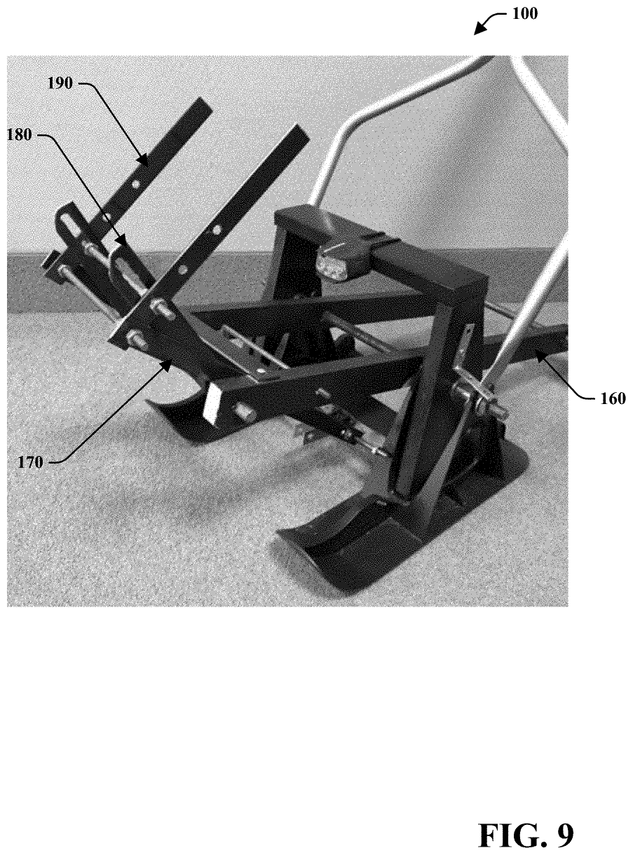

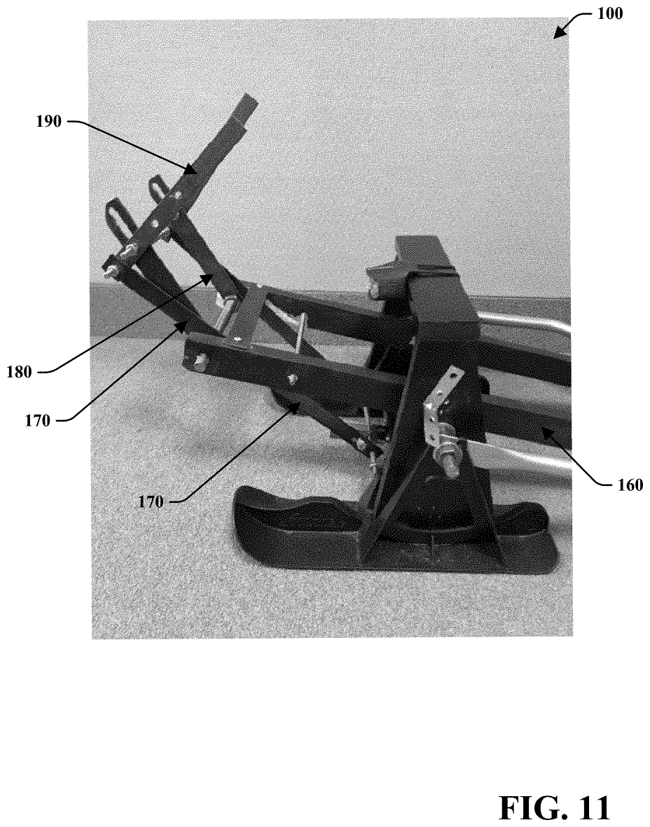

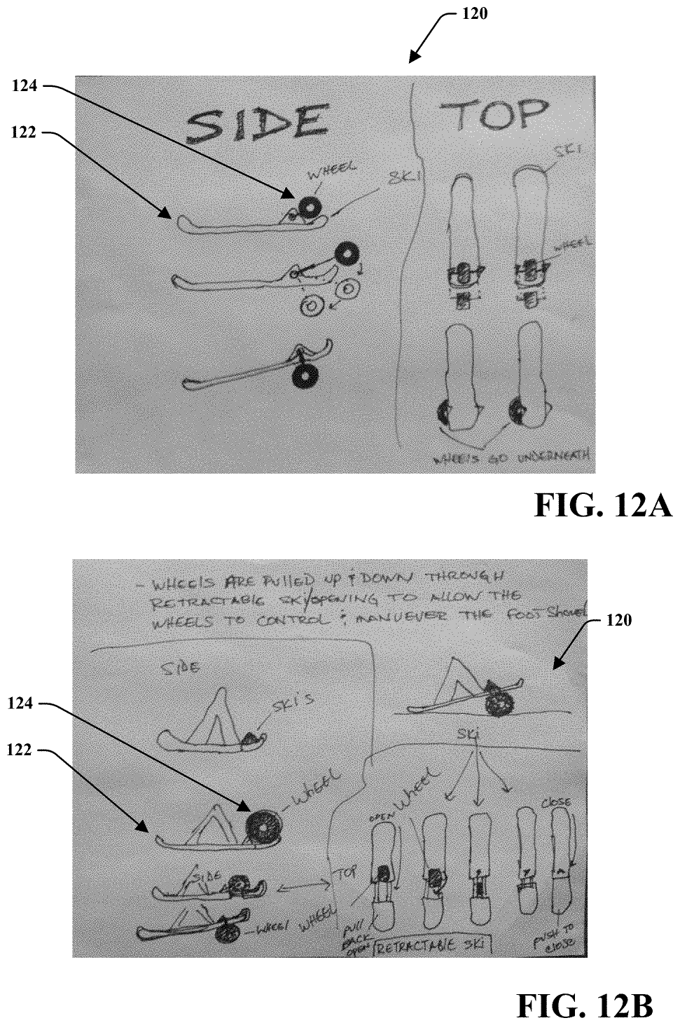

The base 120 of the foot shovel 100 may include at least one member 122 configured to allow lateral movement of the foot shovel 100. In an embodiment, and as shown in FIGS. 1-11, the base 120 may include sliding members 122, such as one or more skis, (e.g., one, two, three, etc.) that enable the foot shovel 100 to traverse a distance. In an embodiment, the base 120 may include at least one wheel 124 that enables the foot shovel 100 to traverse a distance. In an embodiment, the base 120 of the foot shovel 100 may include sliding members 122 and a selectively extendable wheel 124. For example, as shown in FIG. 12A, the wheel 124 may rest on the base 120 in a non-use position. When the wheel 124 is in the non-use position, the user may rely on the sliding members 122 to effectuate movement of the foot shovel 100.

When the user desires to utilize the wheel 124, the wheel 124 may elastically extend over the end of the base 120 to a usable position under the base 120 as shown in FIG. 12A. The base 120 may also open and close to transition a wheel 124 from a non-use position to a usable position as shown in FIG. 12B. In addition to these above examples, any other selective attachment of the wheel 124 may be utilized, including selectively attaching a wheel to a mating member under the base. In some embodiments sliding members 122 may comprise continuous track systems, chained tires, or other devices to assist in moving through snow, ice, or other difficult terrain. Moreover, embodiments may utilize any number of sliding members 122 and combinations of different types of sliding members 122.

The base 120 may further include a light 126 attached to the base 120. The light 126 may comprise an LED or other light source. The light 126 may comprise a power source. The power source may comprise a rechargeable power source, a disposable power source, or the like. In some embodiments, the power source may provide power to the light 126 only, e.g. a battery positioned in or near the light source, or to the light 126 and other components. For example, some embodiments of the foot shovel 100 may include an electronic motor that may operatively lift and release the blade 140, drive the sliding members 122 or the wheel 124, or the like.

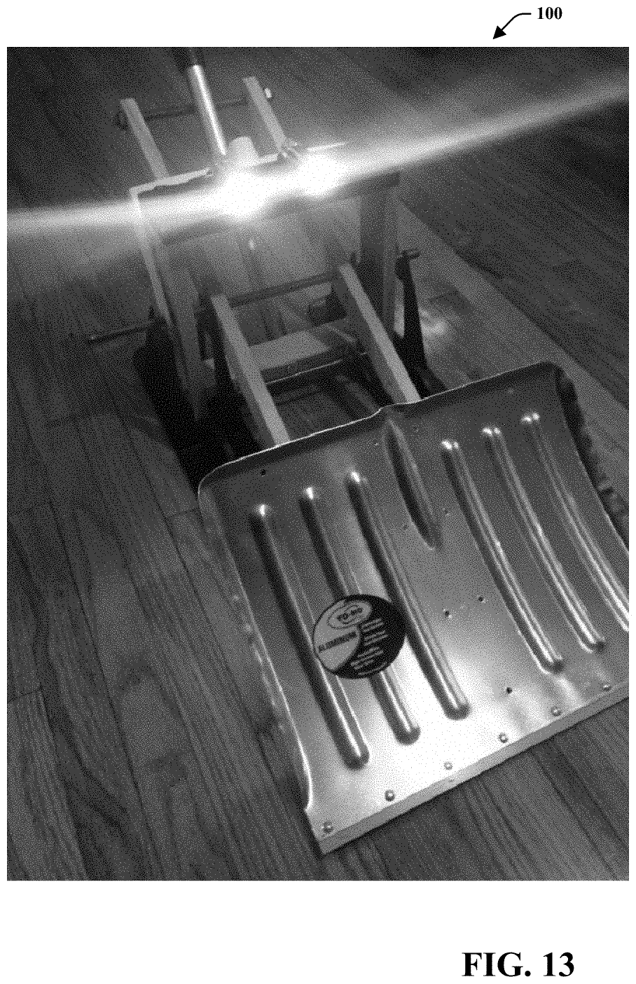

The blade 140 of the foot shovel 100 may include a receiving portion 142 to accommodate a load. The blade 140 may be of any desired shape and size. The blade 140 may be square, rectangular, triangular, concave, spade-shaped, frustoconical, u-blades, v-blades, box plow-type blades, straight plow-type blades, etc., and may be of any size. For instance, the blade 140 may be a shape designed primarily to push (e.g., bulldoze blade shaped), to lift, to carry a particularly sized load, or for a combination thereof. In an embodiment, the blade 140 may generally comprise the shape of a snow-shovel blade. The blade 140 may be detachable from the foot shovel 100. The blade 140 may be detachable from the foot shovel 100 for storage, replacement, maintenance, or to be interchanged with a same or different blade. For instance, the blade 140 may be interchanged with additional attachments of varying sizes and shapes. FIG. 13 depicts an example of an alternative attachment blade. The blade 140 may be attached to the foot shovel 100 via hinges, rotatable attachments or locks, channel locks, bayonet-style locks, fiction fit connections, fasteners, magnets, or the like.

In another aspect, the blade 140 may include a blade or cutting edge disposed proximal the ground when the blade 140 is in the down or resting position. The cutting edge may comprise a metal material (e.g., steel, aluminum, etc.) shaped to scrape ice or other debris, cut through rock, dirt, or rough terrain, and the like. In an embodiment, the blade 140, or other component of the foot shovel 100 such as the slides 122, may include heating elements to cut through snow, ice, or other debris. The heating element may comprise or be coupled to a power source, such as a battery, power mains, gas motor, or the like. The heating element may use air activation or crystallization to produce heat to the surrounding environment. The heating elements may be single or multi-use. In an embodiment, the foot shovel 100 may include a salt dispensing mechanism. The salt dispensing mechanism may operatively dispense salt as the foot shovel 100 travels. This may reduce the amount of time that a user spends outside as well as provide an added safety measure.

The handle 130 of the foot shovel 100 may be selectively attachable to the foot shovel 100 via fasteners, pins, clips, magnets, or the like. The handle 130 may comprise mechanisms to alter the length thereof. For instance, the handle 130 may comprise telescoping tubes or interchangeable components. The handle 130 may include any desired grip size and shape. As shown in FIGS. 1-2, the handle 130 may include a single post having two handles. Alternatively, the handle 130 may include a single post, such as shown by an attachment handle 132, or two posts having a handle therebetween such as that used for a lawnmower. The handle 130 may be selectively attachable to the body 110. The handle 130 may be interchangeable with attachments of varying sizes and shapes.

As shown in FIGS. 1-2, the foot shovel 100 may include an attachment handle 132. The attachment handle 132 may comprise a generally tubular or other appropriately shaped handle. The attachment handle 132 may comprise mechanisms to alter the length thereof, such as telescoping tubes, and may be selectively attachable to the body 110 of the foot shovel 100 via fasteners, pins, clips, magnets, or the like. The attachment handle 132 may be interchanged with the handle 130 of the foot shovel 100. The attachment handle 132, or other variations thereof, may alter the length of the handle, the grip size and positioning of the grips, the type of handle, e.g., bar, single rod, branching dual handle, and the like. It is noted that the attachment handle 132 may be positioned or stored on the body 110 when the attachment handle 132 is not in use, as shown in FIGS. 1-2. The attachment handle 132 may coupled to the body 110 for storage. The attachment handle 132 may extend or alter the reach of the handle 130. The attachment handle 132 may be attached to the body 110 via fasteners, pins, clips, magnets, or the like. In at least one embodiment, the attachment handle 132 and the blade 140 may be detached from the body 110 and operatively attached together to form a standard manual shovel.

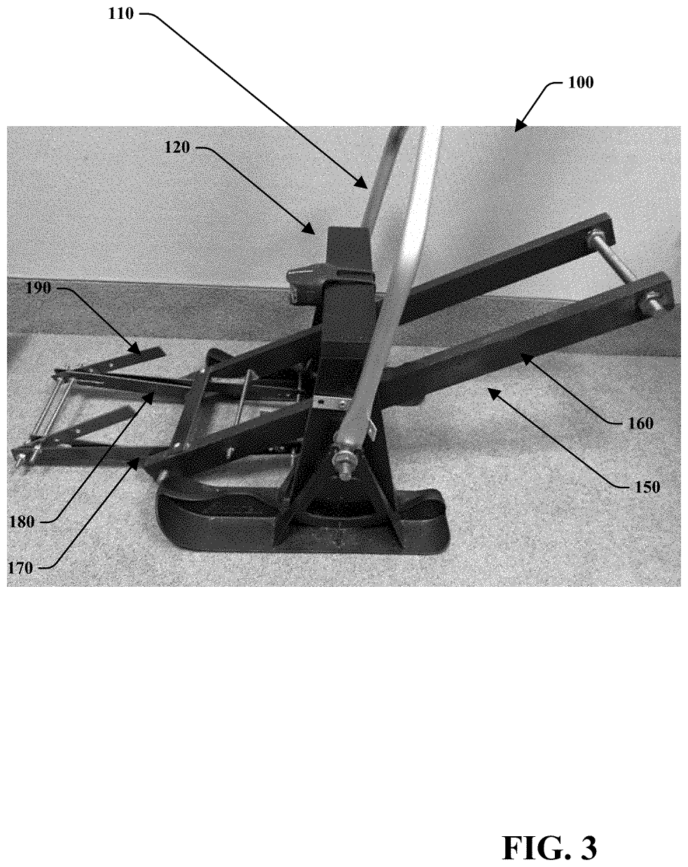

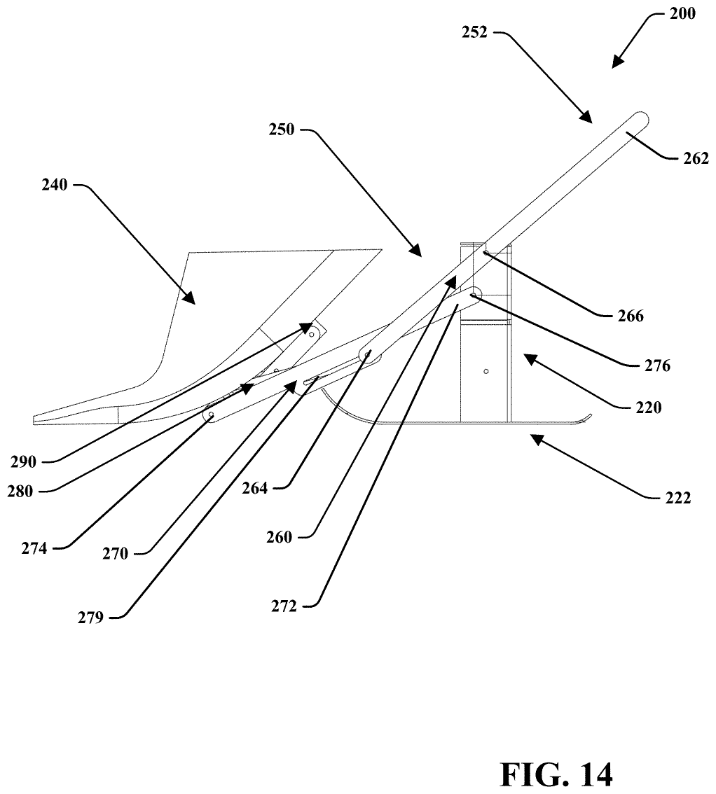

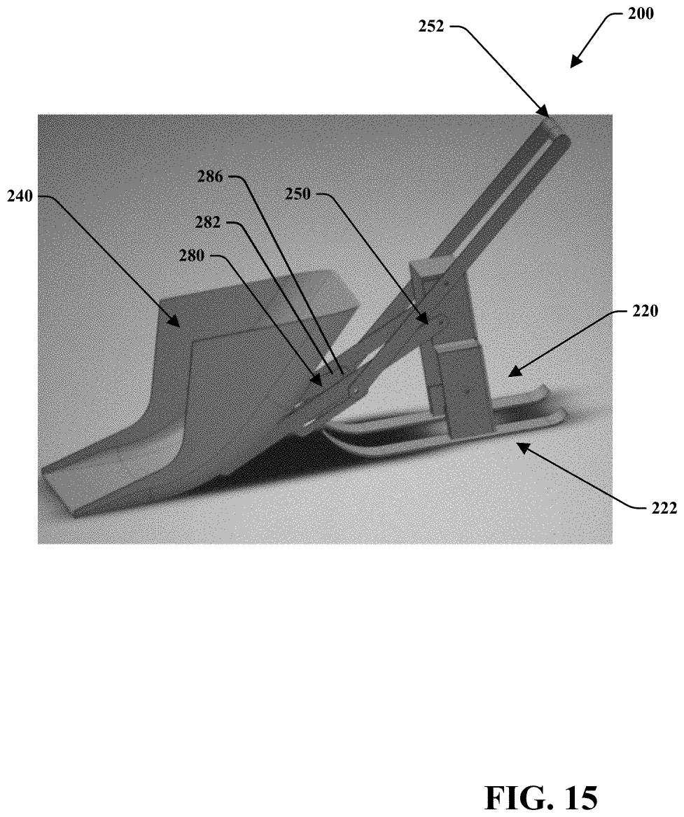

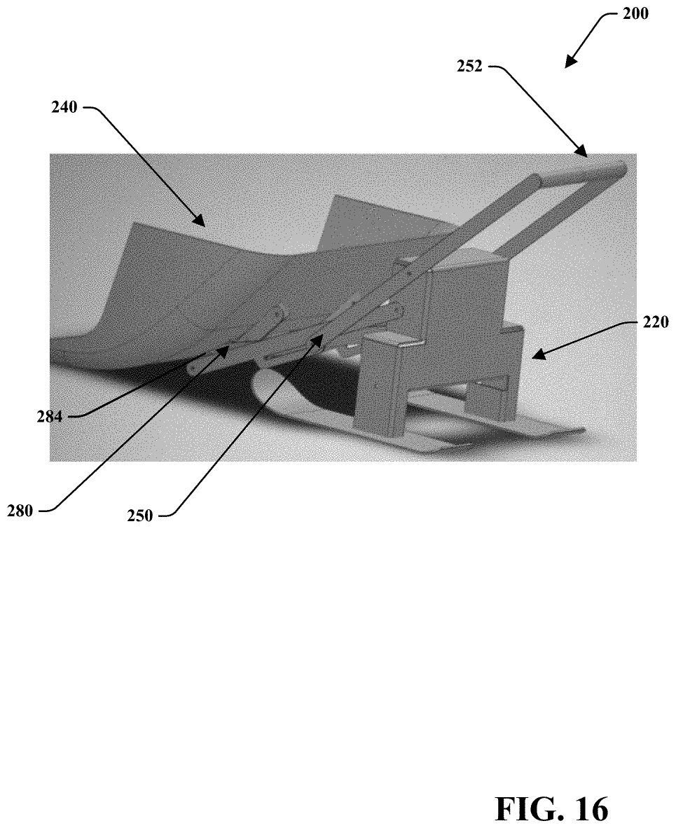

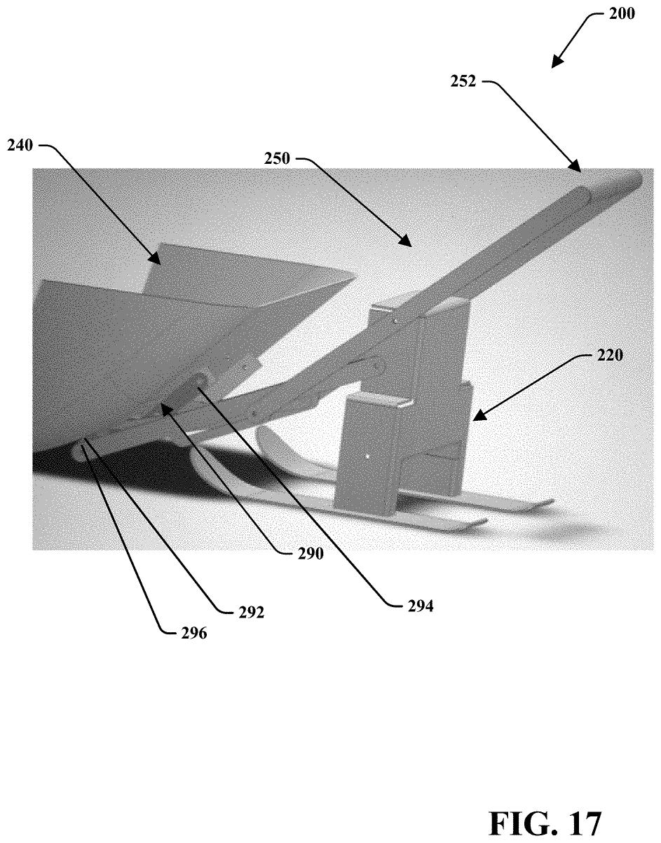

The actuation mechanism 150 of the foot shovel 100 may comprise a multi-lever actuation mechanism. For example, an embodiment of a multi-lever actuation mechanism 150 is shown in FIGS. 3-11. Another embodiment of a multi-lever actuation mechanism 250 is shown in FIGS. 14-17. The actuation mechanism 150 may comprise a plurality of movable members that effectuate a lifting and releasing of a load via the blade 140. The moveable members may include a plurality of fixed and rotatable arms, axes, pivot points, or levers that enable mechanical lifting of the load upon exertion of a first force on an actuator or pedal 152 and a release of the load upon exertion of a second force on the actuator or pedal 152. When the first or second force is stopped or no longer applied, the actuation mechanism may return to a resting or loading position. The lift and release mechanism may be actuated by a manual force, such as a by a user's foot, or the lift and release mechanism may be automated as by, for example, an electric motor or gas powered motor. It is noted that a user's foot may include a prosthetic limb, and that the manual force may also be actuated by a user's hand or other appendage. In an embodiment, actuation may be voice-activated.

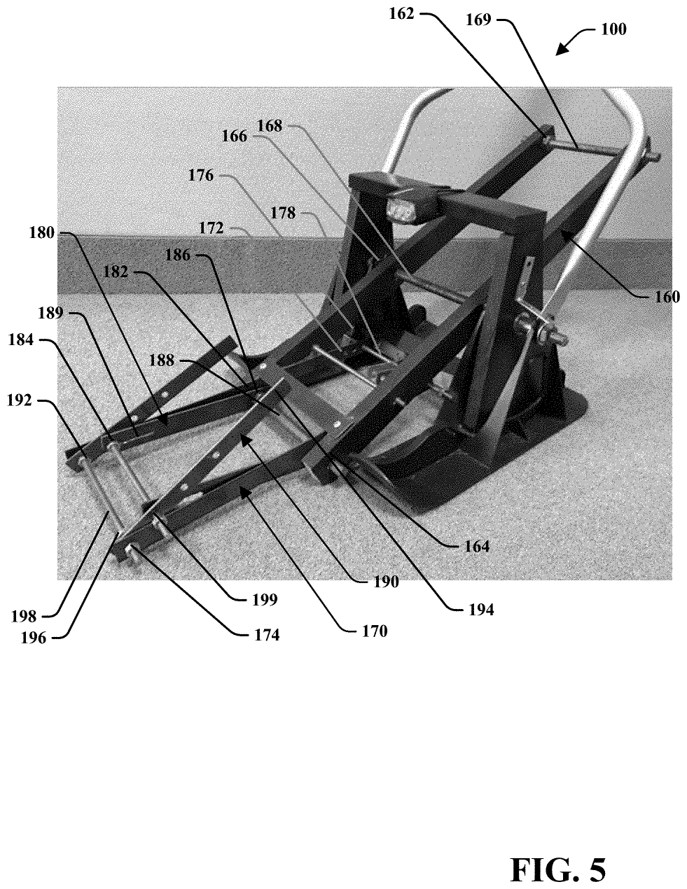

In an embodiment, the foot shovel 100 may comprise a first set of arms 160. The first set of arms 160 may comprise a first end 162 and a second end 164, see FIG. 5 for example. The first set of arms 160 may attach to the base 120 at a point 166 along the length of the first set of arms 160. The point 166 may serve as a fulcrum for the first set of arms 160. In embodiments, the point 166 may include an axle 168 about which the first set of arms 160 rotates. The first set of arms 160 may serve as an actuation member of the actuation mechanism when a force is applied thereon. In an embodiment, the first end 162 of the first set of arms 160 may include a pedal 169 whereby a force, such as a user's foot, may press down on the pedal 169 or first end 162, causing the first set of arms 160 to rotate about the fulcrum defined by the point 166 of attachment to the base 120, and lifting the second end 164 of the first set of arms 160 to further engage the remaining portion of the lift and release mechanism, compare FIGS. 5-11.

In an embodiment, the foot shovel 100 may further comprise a second set of arms 170. The second set of arms 170 may comprise a first end 172 and a second end 174. The first end 172 of the second set of arms 170 may attach to the base 120 at a point 176. The point 176 may serve as a fulcrum for the second set of arms 170. In embodiments, the point 176 may include an axle 178 about which the second set of arms 170 rotates. The second set of arms may selectively rest on an axle 188 located on the second end 164 of the first set of arms 160. The second end 164 of the first set of arms 160 may act as a guide to the second set of arms 170 such that as the first set of arms 160 rotates about the axis defined by its point 166 of attachment to the base 120, the second end 164 of the first set of arms 160 slides up the second set of arms 170 and lifts the second set of arms 170 upwards. The second set of arms 170 may rotate about the axis defined by its point 176 of attachment (between the first end 172 and the base 120) as the second end 164 of the first set of arms 160 lifts upwards, compare FIGS. 5-11. As described herein, in another embodiment of the foot shovel 200, the second set of arms may include a slot that slidably engages with the second end of the first set of arms, see FIGS. 14-17.

In an embodiment, the foot shovel 100 may further comprise a third set of arms 180. The third set of arms 180 may comprise a first end 182 and a second end 184. The first end 182 of the third set of arms 180 may attach to the second end 164 of the first set of arms 160 at a point 186. The point 186 may serve as a fulcrum for the third set of arms 180. In embodiments, the point 186 may include an axle 188 about which the third set of arms 180 rotates. While the FIGs. illustrate the rotation axle 188 of the third set of arms 180 as the same axle 188 that the second set of arms 170 may rest on, it is noted that these axles may be different. The second end 184 of the third set of arms 180 may comprise a slot 189 to further engage the remaining portion of the lift and release mechanism, compare FIGS. 5-11.

In an embodiment, the foot shovel 100 may further comprise a fourth set of arms 190. The fourth set of arms 190 may comprise a first end 192 and a second end 194. The first end 192 of the fourth set of arms 190 may attach to the second end 174 of the second set of arms 170 at a point 196. The point 196 may serve as a fulcrum for the fourth set of arms 190. In embodiments, the point 196 may include an axle 198 about which the fourth set of arms 190 rotates. The fourth set of arms 190 may attach to the third set of arms 180 at a point 199 within the slot 189 of the third set of arms 180. The second end 194 of the fourth set of arms attaches to the blade 140 of the foot shovel 100.

As an example, as the first set of arms 160 rotates about the axis defined by its point 166 of attachment to the base 120, and as the second end 164 slides up the second set of arms 170, raising the second set of arms 170, the slotted attachment 189 between the second end 184 of the third set of arms 180 and the point of attachment 199 on the fourth set of arms 190 moves so that the third set of the arms 180 moves upwards and the fourth set of arms 190 remains substantially horizontal to the ground while rotating about the point 196 of attachment to the second set of arms 170. During the lifting movement, the blade 140 attached to the fourth set of arms 190 is able to remain substantially horizontal to the ground as shown in FIGS. 5-7 depicting the progression of the foot shovel 100 from a resting to a lifting position as a force (not shown) is applied downwards onto the first end 162 of the first set of arms.

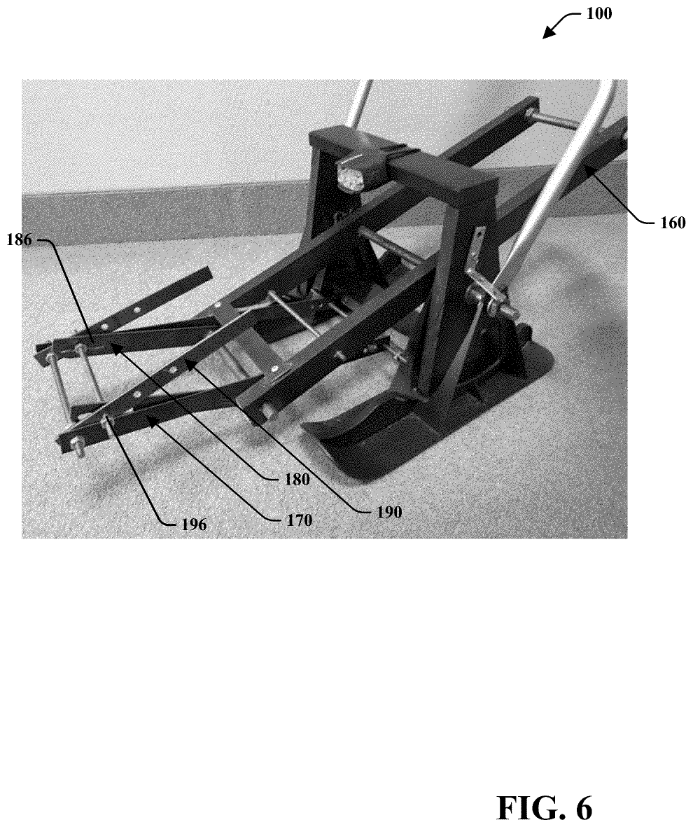

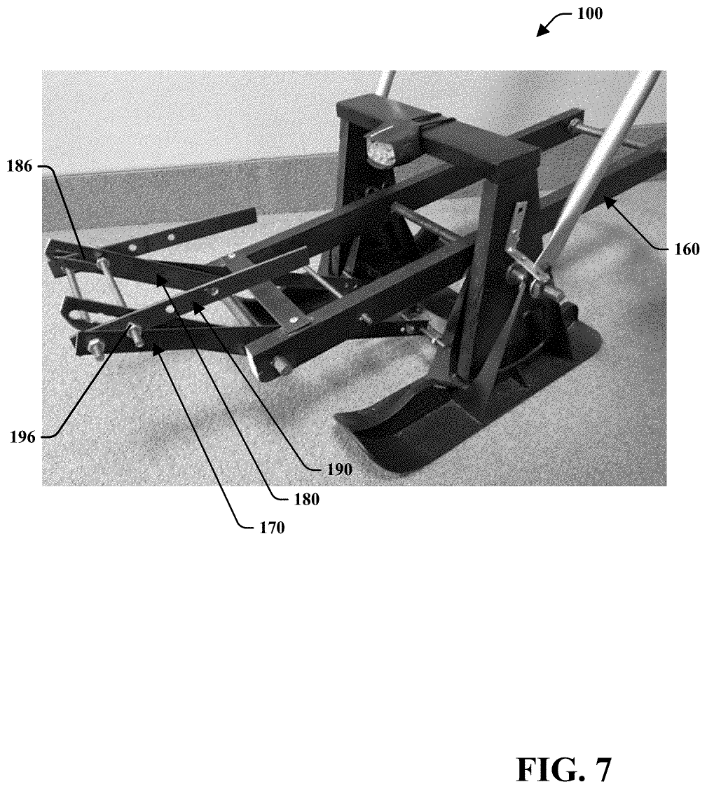

As is shown in FIGS. 5-7, in a resting position of FIG. 5, the point of attachment 199 on the fourth set of arms 190 remains on one side of the slot 189 of the second end 184 of the third set of arms 180. As lifting begins from the resting position, the point of attachment 199 on the fourth set of arms 190 moves across the slot 189, shown in FIG. 6, to the other end of the slot 186, shown in FIG. 7. The end of the slot 189 serves as a natural stop to the lifting mechanism.

The first set of arms 160 may be locked in place at its point of attachment 166 to the base 120 to prevent further rotation back down to a resting position or up further into the release position of the foot shovel 100. The actuation mechanism 150 may be locked by other mechanisms and at other points in the actuation mechanism 150 as desired. For example, the first set of arms 160, second set 170, third set 180, and/or fourth set 190 may be individually or collectively locked by a locking mechanism. The actuation mechanism 150 may also automatically lock as it progresses through actuation so that the user may discontinue force at any time and the actuation mechanism 150 will stay in place. A user may then either reestablish the force and continue through actuation, or engages a release that may bring the actuation mechanism 150 back to a resting position. When locked, no additional force may be needed to maintain the position of the actuation mechanism 150. For example, the user may be free to walk with the foot shovel 100 to traverse a distance while holding a load in the lifting position.

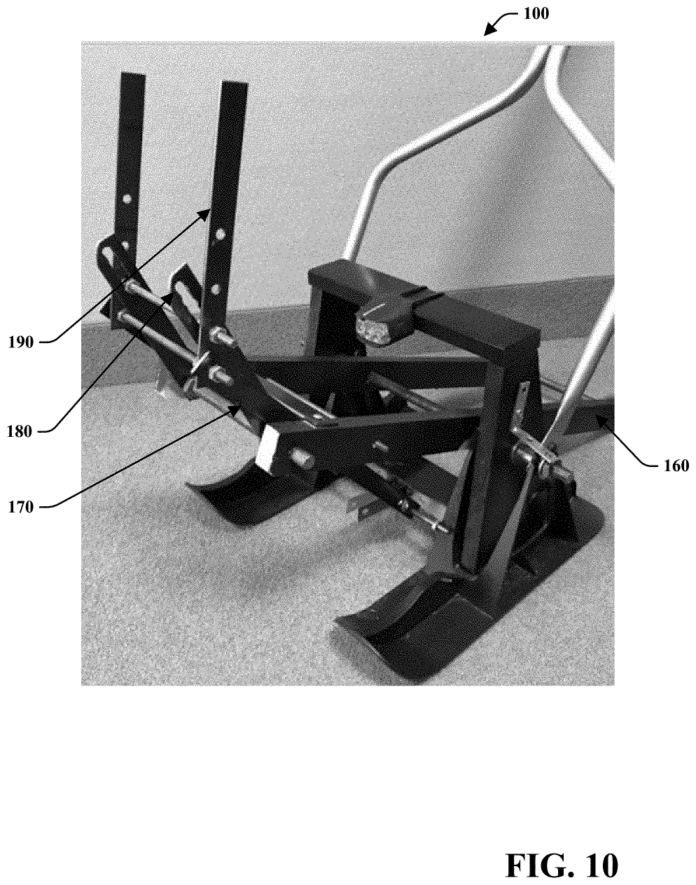

When desired, a user may unlock the actuation mechanism 150 or continue through the progression to bring the actuation mechanism to a lifting position, as shown in FIGS. 7-11. Once the point of attachment 199 on the fourth set of arms 190 traverses the slot 189 of the second end 184 of the third set of arms 180, to its natural stopping point at the end of the slot 189, an additional force may exerted onto the first end 162 of the first set of arms 160. This additional force may continue to lift the second end 164 of the first set of arms 160 and the second 170 and third set of arms 180. At this point, the fourth set of arms 190 may begin to rotate at the point of attachment 196 between the first end 192 of the fourth set of arms 190 and the second end 174 of the second set of arms 170, defining an axis. As shown in FIGS. 7-11, as the fourth set of arms 190 may rotate about the point 196 defined by its attachment to the second set of arms 170, the blade 140 (not shown) may transition from a substantially horizontal position, as in FIG. 7, to a substantially vertical position to release the load held in the blade 140, as in FIG. 10. In an embodiment, the blade 140 and fourth set of arms 190 may become substantially vertical about when the first end 162 or pedal of the first set of arms 160 would reach the ground.

Once a load is released, the user may discontinue force on the first end 162 or pedal 169 of the first set of arms 160 and the actuation mechanism 150 may revert back to a resting position. The above-described transitioning of the actuation mechanism 150 may be repeated as desired. Although the above describes an actuation mechanism including four sets of arms, it is noted that any number of arms may be sufficient including one, two, three, four, five, six, seven, eight, etc. sets of arms. In an embodiment, the actuation mechanism 150 of the foot shovel 100 may generally a lever mechanism to lift a load held in the blade 140, and a slotted lever mechanism to release the load held in the blade 140. During a first rotation to lift the blade 140 from a resting position to a lifting position, a portion of the lever mechanism 150 may traverse or pass through the length of the slot 189 until a stop point. At the stop point, a second rotation may begin to cause the blade 140 to rotate and release the load.

FIGS. 14-17 show another embodiment of the actuation mechanism 250 of a foot shovel 200. The foot shovel 200 may otherwise be the same as or similar to foot shovel 100 and may comprise a body 210, a base 220, a handle 230, and a blade 240 as well as other features described herein as they relate to foot shovel 100, such as at least one member 222 configured to allow lateral movement of the foot shovel 200 and actuator or pedal 252. The actuation mechanism 250 may comprise a multi-lever actuation mechanism.

The actuation mechanism 250 may comprise a plurality of movable members that effectuate a lifting and releasing of a load via the blade 240. The moveable members may include a plurality of fixed and rotatable arms, axes, pivot points, or levers that enable mechanical lifting of the load upon exertion of a first force on the actuator or pedal 252 and a release of the load upon exertion of a second force on the actuator or pedal 252. When the first or second force is stopped or no longer applied, the actuation mechanism may return to a resting or loading position. The lift and release mechanism may be actuated by a manual force, such as a by a user's foot, or the lift and release mechanism may be automated as by, for example, an electric motor or gas powered motor. It is noted that a user's foot may include a prosthetic limb, and that the manual force may also be actuated by a user's hand or other appendage. In an embodiment, actuation may be voice-activated.

The actuation mechanism 250 may comprise a first set of arms 260, a second set of arms 270, a third set of arms 280, and a fourth set of arms 290. In an embodiment, the handle 230 of the foot shovel 200 may serve as the actuator and the body 210 may serve as the first set of arms that then attaches and interacts with the other components of the actuation mechanism 250. In an embodiment, the first set of arms 260 may comprise a first end 262 and a second end 264. The first set of arms 260 may attach to the base 220 at a point 266 along the length of the first set of arms 260. The point 266 may serve as a fulcrum for the first set of arms 260 to rotate about. The first set of arms 260 may serve as an actuation member of the actuation mechanism when a force is applied thereon. In an embodiment, the first end 262 of the first set of arms 260 may include a pedal 269 whereby a force, such as a user's foot, may press down on the pedal 269 or first end 262, causing the first set of arms 260 to rotate about the fulcrum defined by the point 266 of attachment to the base 220, and lifting the second end 264 of the first set of arms 260 to further engage the remaining portion of the lift and release mechanism.

In an embodiment, the foot shovel 200 may further comprise a second set of arms 270. The second set of arms 270 may comprise a first end 272 and a second end 274. The first end 272 of the second set of arms 270 may attach to the base 220 at a point 276. The point 276 may serve as a fulcrum for the second set of arms 270 to rotate about. The second set of arms may include a slot 279. The second end 264 of the first set of arms 260 may be slidably engaged with the slot 279 of the second set of arms 270 such that as the first set of arms 260 rotates about the axis defined by its point 266 of attachment to the base 220, the second end 264 of the first set of arms 260 slides through the slot 279 on the second set of arms 270 until a stop point and lifts the second set of arms 270 upwards. The second set of arms 270 may rotate about the axis defined by its point 276 of attachment (between the first end 272 and the base 220) as the second end 264 of the first set of arms 260 lifts upwards.

In an embodiment, the foot shovel 200 may further comprise a third set of arms 280. The third set of arms 280 may comprise a first end 282 and a second end 284. The first end 282 of the third set of arms 280 may attach to the second end 264 of the first set of arms 260 at a point 286. The point 286 may serve as a fulcrum for the third set of arms 280 to rotate about. The second end 284 of the third set of arms 280 may comprise a slot 289 (not shown) to further engage the remaining portion of the lift and release mechanism. It is noted that the third 280 and fourth 290 sets of arms in foot shovel 200 may generally be the same as or similar to the third 180 and fourth 190 sets of arms in foot shovel 100, including the same or similar points of attachment and lifting mechanisms. In an embodiment, the third 280 and fourth 290 sets of arms in foot shovel 200 are the same as the third 180 and fourth 190 sets of arms in foot shovel 100, including the same points of attachment and lifting mechanisms.

In an embodiment, the foot shovel 200 may further comprise a fourth set of arms 290. The fourth set of arms 290 may comprise a first end 292 and a second end 294. The first end 292 of the fourth set of arms 290 may attach to the second end 274 of the second set of arms 270 at a point 296. The point 296 may serve as a fulcrum for the fourth set of arms 290 to rotate about. The fourth set of arms 290 may attach to the third set of arms 280 at a point 299 (not shown) within the slot 289 of the third set of arms 280. The second end 294 of the fourth set of arms attaches to the blade 140 of the foot shovel 100.

As an example, to move from a resting position to a lifting position, the first set of arms 260 may rotate about the axis defined by its point 266 of attachment to the base 220, and the second end 264 may slide through the slot 279 on the second set of arms 270 until a stop point, raising the second set of arms 270. The interactions between the second 270, third 280, and fourth 290 set of arms may be the same as described herein in relation to foot shovel 100, noting that the slot 279 relates to the interaction between first 260 and second 270 arms.

Although the embodiments of the present teachings have been illustrated in the accompanying drawings and described in the foregoing detailed description, it is to be understood that the present teachings are not to be limited to just the embodiments disclosed, but that the present teachings described herein are capable of numerous rearrangements, modifications and substitutions without departing from the scope of the claims hereafter. The claims as follows are intended to include all modifications and alterations insofar as they come within the scope of the claims or the equivalent thereof.

What is claimed is:

1. A foot shovel including a pedal-activated lift and release mechanism, the foot shovel comprising:
a body having a first end and a second end,
a base disposed at the first end of the body, the base comprising at least one member configured to allow lateral movement of the foot shovel,
a handle disposed at the second end of the body,
a blade configured to receive and hold a load, and
a multi-lever actuation mechanism, wherein the multi-lever actuation mechanism is configured to lift the blade to a lifting position by a first force and rotate the blade to a release position by a second force.

2. The foot shovel of claim 1, wherein the multi-lever actuation mechanism comprises a slot and a rod, wherein the rod moves from a start point in the slot to a stop point in the slot as the foot shovel moves from a resting position to the lifting position.

3. The foot shovel of claim 2, wherein the multi-lever actuation mechanism maintains the blade in a non-vertical position as the rod moves in the slot and as the foot shovel moves from a resting position to the lifting position.

4. The foot shovel of claim 2, wherein multi-lever actuation mechanism rotates the blade to a vertical position when the rod hits the stop point and as the foot shovel moves from the lifting position to the release position.

5. The foot shovel of claim 1, wherein the multi-lever actuation mechanism comprises a first set of arms having a first and a second end, wherein the set of arms is anchored to the base at a first rotatable point and the first end serves as the actuator of the multi-lever actuation mechanism.

6. The foot shovel of claim 5, wherein the multi-lever actuation mechanism further comprises a second set of arms having a first and a second end, wherein the first end is anchored to the base at a second rotatable point and the second end of the first set of arms serves as a slidable guide to the second set of arms.

7. The foot shovel of claim 6, wherein the multi-lever actuation mechanism further comprises a third set of arms having a first and a second end, wherein the first end is anchored to the second end of the first set of arms at a third rotatable point, and the second end comprises a slot.

8. The foot shovel of claim 7, wherein the multi-lever actuation mechanism further comprises a fourth set of arms having a first and a second end, wherein the first end is anchored to the second end of the second set of arms at a fourth rotatable point, the fourth set of arms are slidably engaged with the slot of the third set of arms.

9. The foot shovel of claim 8, wherein the blade is anchored to the fourth set of arms.

10. The foot shovel of claim 9, wherein the first set of arms are configured to rotate about the first rotatable point, the second set of arms are configured to rotate about the second rotatable point, the third set of arms are configured to rotate about the third rotatable point, the fourth set of arms are configured to rotate about the fourth rotatable point, and the fourth set of arms are configured to slide across the slot to a stop point,
as the foot shovel moves from a resting position to the lifting position.

11. The foot shovel of claim 10, wherein the fourth set of arms remains substantially parallel to the ground as the foot shovel moves from a resting position to the lifting position.

12. The foot shovel of claim 11, the fourth set of arms are configured to rotate about the stop point as the foot shovel moves from the lifting position to the release position.

13. The foot shovel of claim 12, wherein the fourth set of arms rotates to a substantially perpendicular position as the foot shovel moves from the lifting position to the release position.

14. The foot shovel of claim 1, wherein the multi-lever actuation mechanism is actuated by a manually-applied downward force onto the first end of the first set of arms.

15. The foot shovel of claim 1, wherein the body is adjustable in angle.

16. The foot shovel of claim 1, wherein the at least one member configured to allow lateral movement of the foot shovel is a sliding member.

17. The foot shovel of claim 1, wherein the at least one member configured to allow lateral movement of the foot shovel is a wheel.

18. The foot shovel of claim 1, wherein the blade is removable and interchangeable.

19. A foot shovel including a pedal-activated lift and release mechanism, the foot shovel comprising:
a frame having a body and a handle,
a base operatively attached to the body, the base comprising at least one member configured to allow lateral movement of the foot shovel,
a blade configured to receive and hold a load, and
a multi-lever actuation mechanism comprising at least one set of rotatable arms, a sliding member, and a slot, wherein the sliding member is slidably engaged with the slot.

20. The foot shovel of claim 19, wherein the sliding member slides through the slot to a stop point as the foot shovel moves from a resting position to a lifting position, and the sliding member causes the blade to rotate at the stop point to move the shovel from a lifting position to a release position.
